(19) United States
(12) Patent Application Publication
(10) Pub. No.: US 2005/0115488 A1
(43) Pub. Date: Jun. 2, 2005

(54) Alarm arrangement

(76) Inventor: Bengt Westby, Harnosand (SE)

Correspondence Address: FASTH LAW OFFICES, 629 E. BOCA RATON ROAD, PHOENIX, AZ, 85022, US

(21) Appl. No.: 10/967,961

(22) Filed: Oct. 19, 2004

(30) Foreign Application Priority Data
Oct. 29, 2003 (SE) 0302877-6

(51) Int. Cl. G08B 1/00

(52) U.S. Cl. 116/200

(57) ABSTRACT

The invention is an alarm arrangement and mainly an acoustic arrangement. The alarm arrangement has an explosive unit (14) that may include a common starter bullet. The invention may advantageously be used for ice fishing. In combination with loaded trip wires, the alarm arrangement can also be used in many applications where it is important to protect both real property and animals. The alarm arrangement is provided with a first plate (7) that has one end with a striker pin (10). The plate is connected to an end (5) of a second plate by a hinge-like connector (6). A foldable plate is connected to a tensioning arrangement (11) and the alarm arrangement includes an explosive unit. The invention is characterized, among other things, by connecting the explosive unit to the alarm arrangement by a cavity (3) of the plate (2). The explosive unit is held to the plate by a collar (15). The explosive unit has a starter bullet that includes a gun powder. The tensioning arrangement of the arrangement has preferably a spiral spring. Another characterized feature of the invention is that one end (12) of the tensioning arrangement is attached to the foldable plate at a distance that is closer to the striker pin of the plate than the mid-point of the plate.

The present invention relates to an alarm arrangement that is primarily an acoustic arrangement. The alarm arrangement is among other things equipped with an explosive unit that can include conventional starter bullets. The invention may advantageously be used for ice fishing. In combination with the set up of a tripwire the alarm arrangement can also be used in many applications where it is important to protect both real property and animals.

### PRIOR ART

Alarm arrangement that provides an alarm through acoustic signals is generally known in many designs and are used in many different applications. For example, acoustic alarm arrangements are used in winter fishing with bendable locking arms.

In U.S. Pat. No. 2,924,038 a fishing device is described that is mainly for winter fishing that includes an acoustic alarm arrangement. The acoustic alarm arrangement includes a bell that, when fish bites the bait, is moved and thus provides a sound. The arrangement has the drawback of giving a false alarm when windy and that it does not provide a sufficiently strong alarm to ensure that it is noticed. Fishing equipment with acoustic alarms, that are created electrically, is described in US patent U.S. Pat. No. 4,246,716. When fish bites a circuit is connected so that an acoustic signal is sent via a loudspeaker of the fishing device. The arrangement is battery operated and is not entirely reliable in cold weather.

Acoustic alarm arrangement that use explosive units are knows in winter fishing with commonly used ice fishing equipment. When ice fishing it is common to drill numerous holes in the ice and then place the ice fishing equipment at each hole. To avoid having to constantly observe, the ice equipment are normally equipped with arrangement for providing both acoustic signals and visual signals when a fish has engaged the hook. The acoustic signal gets the fisherman's attention during fish engagement while the visual signal shows which ice equipment has created the acoustic signal.

The visual signaling arrangement normally includes an elongate steel spring blade that has one end attached to the equipment and the other end has a signaling flag or another color marking. The visual signaling arrangement is the trigger for the acoustic signaling arrangement that has a cork detonator placed in a cork detonator mechanism in a generally known design.

The cork detonator mechanism has an attachment place that is attached to the device. The attachment plate includes a number of bent segments that are intended to hold the cork detonator. An arm is rotatably attached to the attachment and a free end of the arm includes a striker point. Between the arm and the attachment plate a pulling spring is attached. The pulling spring has the function of providing the arm with a sufficient swinging force against the cork detonator so that it is triggered. The pulling spring also enables the mechanism to be maintained in a loaded position.

The acoustic signaling arrangement is loaded by pulling out the fishing line that is sunk with the hook and bate down through a hole that is normally drilled through the ice. When a suitable length of the line has been pulled out and lowered according to the water depth, a loop is made in the line. The loop is hung in the outer end of the steel spring in a way so that it is released when a fish bites the hook. The arm on the acoustic alarm arrangement is loaded against the steel spring. When the angle between the arm and the attachment plate is greater than 180 degrees, the pulling spring holds the arm against the steel spring. When a fish bites, the line is pulled downwardly so that the visual signaling arrangement is released. The steel spring bounces back and thus affects the loaded arm so that the angle between the arm and the holder unit is less than 180 degrees so that the mechanism closes and the striker point triggers the cork detonator. The fisherman is thus alerted that a fish has nibbled on the hook.

The handling of cork detonators is not entirely risk free. Tests have thus shown that during the free fall from a high height boxes with cork detonators can explode.

Another drawback is that the cork component can no longer be freely harvested. This circumstance has resulted in that cork detonators are relatively costly.

### DESCRIPTION OF THE INVENTION

The invention includes among other things two plates of which at least one plate can be folded towards and away from a second plate. The plate can be made of sheet metal or plastic. The foldable plate has a striker point at one end. The two plates are at each end attached to one another with a hinge-like connector. The plate that lacks the striker point has a cavity that is used as a seat for an explosive unit in the form of the common starter bullets. Within the scope of the invention the same plate can advantageously be attached to a fixed support that can be of wood, steel or plastic.

Characterized for the invention is that the fixed support has a cavity that is mainly situated below the earlier mentioned cavity of the plate and preferably has the same diameter as the cavity of the plate.

Because the explosive unit may have charges including gun powder, among other things, the described cavity in the plate and the support that, for example, the starter bullet flies out from its seat. From an environmental point of view that is important while making it substantially easier to collect and recycle used bullets. In order to collect used bullets, the alarm arrangement can be provided with a suitable sleeve or sock that collects the starter bullet.

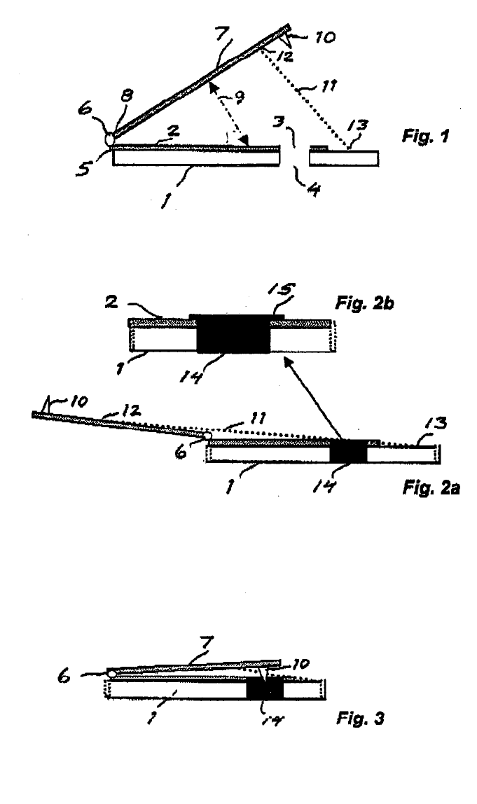

The release of the explosive unit can be accomplished by the striker point of the foldable plate that with force hits, for example, the starter bullet. To be able to initiate this striker force, the plates are folded away from one another so that their outer ends are at a substantially maximum distance away from one another. A tensioning arrangement is attached to the foldable plate that preferably includes a spiral spring. The tensioning arrangement can of course also include an elastic band of rubber. A characterizing part of the invention is that one end of the tensioning arrangement is attached to the foldable plate at a distance that is closer to the striker point of the plate than the mid-point of the plate. With support of FIGS. 1-4, the invention is now described in more detail.

FIG. 1 shows a simple view of the arrangement seen from the side

FIG. 2a shows like FIG. 1 a view of the arrangement seen from the side wit the difference that the arrangement is loaded with an explosive unit

FIG. 2b shows a detail of FIG. 2a and more particularly the application of the explosive unit

FIG. 3 shows a side perspective view of a striker point hitting the explosive unit

FIG. 1 shows the alarm arrangement secured to a support 1 made of an optional material. One plate 2 of the arrangement, that has a cavity 3, rests against the support. The support 1 also has a similar cavity 4 that extends through the thickness of the support. The described plate is at one end 5 via a hinge-like connector 6 connected to an end 8 of a second foldable plate 7. The foldability of the plate is shown in FIG. 1 with the help of the force arrow 9. The foldable plate has a striking pin 10. One end 12 of a tensioning arrangement 11 is also attached to the foldable plate while a second end 13 is connected to the support 1.

The view in FIG. 1 demonstrates how the folded plate is about to be unfolded away from the plate that rests on the support. FIG. 2a demonstrates how the outer ends of the plates are substantially at a maximum distance from one another. This means that the tensioning arrangement is in tension to provide a high effect when released by an alarm.

FIG. 2b shows an enlarged view of how an explosive unit 14 has been placed in the cavity (3, 4) of the alarm arrangement. As is shown in FIG. 2b, the explosive unit has a collar 15 that rests on the support and a portion of the plate 2. This application of the explosive unit ensures that it lies safely in the cavity of the arrangement.

By using the tensioned spring or a trip wire (not shown in the figures) the acoustic alarm is released and the foldable plate 7 so that the striker pin 10 hits the explosive unit 14 with a high force and precision. Thanks to the firm attachment of the explosive unit to the support, and the cavity of the arrangement, it is easy to take care of and recycle the remainders of the used unit. Additional reinforcement of the recycling concept can be accomplished if the arrangement is provided with some sort of collector such as a sleeve or sock.

Many of the drawbacks of the currently available acoustic alarm arrangements can be eliminated or be substantially reduced by using the present invention. The explosive units are thus engaged with the alarm arrangement in a substantially saver way compared to the common arrangement and particularly ice fishing devices.

Another advantage is that it does not require a protected raw material, such as cork, to make the alarm arrangement according to the invention. This circumstance results in that the price of the arrangement of the invention is substantially lower than using known arrangements with a cork detonator for the creation of the acoustic alarm.

1. An acoustic alarm arrangement having a first plate (7) having an end with a striker pin (10), the plate being connected to an end of a second plate (5) with a hinge-like connector (6), a tensioning arrangement is attached to a foldable plate, the alarm arrangement has an explosive unit (14) characterized therein that the explosive unit is in engagement with the alarm arrangement by a cavity defined in the second plate, the explosive unit being held to the plate by a collar (15), the acoustic alarm being triggered by the striker pin (10) of the foldable plate.

2. The acoustic alarm arrangement according to claim 1 characterized therein that the explosive unit is a starter bullet that includes a gun powder.

3. The acoustic alarm arrangement according to claim 1 characterized therein that the tensioning arrangement includes a spiral spring.

4. The acoustic alarm arrangement according to claim 1 characterized therein that the tensioning arrangement includes an elastic band of rubber.

5. The acoustic alarm arrangement according to claim 1 characterized therein that one end (12) of the tensioning arrangement is attached to the foldable plate to a position that is closer to the striker pin of the plate than a mid-point of the plate.

6. The acoustic alarm arrangement according to claim 1 characterized therein that the alarm arrangement has a collector in the form of a sleeve or sock for collection of used explosive units.
